(19) United States
(12) Patent Application Publication
(10) Pub. No.: US 2005/0111931 A1
(43) Pub. Date: May 26, 2005

(54) Clinched thread saver

(76) Inventors: Patrick H. Hool, St. Clair, MI (US); John Cassidy, Brighton, MI (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 11/024,354

(22) Filed: Dec. 28, 2004

Related U.S. Application Data
(62) Division of application No. 10/389,310, filed on Mar. 14, 2003.

(51) Int. Cl. F16B 13/06

(52) U.S. Cl. 411/61

(57) ABSTRACT

A thread saver for use in a body, wherein the thread saver has a threaded interior and the thread saver is permanently fixed the body.

### BACKGROUND OF THE INVENTION

This invention relates in general to a device for preventing damaged screw threads in a body.

For the ease of description, in this application the term “thread insert” should be taken to mean a device used to restore threads to a damaged component and the term “thread saver” will be used to refer to a device used to prevent thread damage to a component.

There are many port fittings on the marketplace currently which are designed to connect tubing or hydraulic hose to threaded bores formed in the body of a hydraulic component such as, those formed in an industrial hydraulic system or those formed in vehicle hydraulic brake systems such as, brake calipers, master cylinders, Hydraulic Control Units (HCUs), etc. Two frequently used arrangements for attaching tubing to such a body are the tube-to-port and the “banjo” type fittings. The former is frequently used in vehicle brake, power steering, and air conditioning systems, while the latter is frequently used in vehicle brake systems.

Occasionally during primary assembly or during reassembly after service or system repair, the threads of a port fitting may be cross-threaded with the internal screw threads of a threaded bore in the body, with the undesired result that the threads cut into the bore of the body may become damaged. This may occur, for instance, when assembling systems such as hydraulic brake systems, where long and relatively inflexible brake line tubes are to be connected to bodies such as master cylinders or HCUs. The tubes are difficult to precisely coaxially align with an associated threaded bore in the body. When tube nuts sliding along the brake line tubes are slid into position to be threaded into the threaded bores, the tube nuts may be held by the brake line tubes in misaligned position, leading the installer to cross thread the tube nuts.

When internal screw threads cut into a body become damaged, chasing the damaged thread with a tap to restore the thread shape can sometimes functionally repair them. However, if the thread is damaged to such an extent that chasing with a tap will not restore the thread's function, the threads must be replaced. Boring out the original threads with a drill larger than the major diameter of the thread and rethreading the hole with a larger diameter thread can do this. While this method will provide a usable threaded hole, this method will require a fastener or connector of a different size than the original. In an assembly which must be disassembled and reassembled periodically, this method requires that tools with different head sizes are needed. This is, at the very least, inconvenient and may result in difficulty for those reassembling the device. Additionally, it provides an opportunity for error when a non-standard part is used, in that a vehicle service technician, for example, may not recognize that a non-standard repair part was used, and upon reassembly, incorrectly use a standard part for reassembly of such a repaired part following service in the field. The process of re-tapping or chasing a deformed thread to render it useable again is also highly likely to generate metallic particulates that will contaminate the hydraulic system. These contaminants can be very destructive to system components that require high levels of cleanliness such as master cylinders or ABS valves.

In order to replace the damaged thread with the same thread as the original assembly, one can bore the damaged thread out and thread the hole with a larger diameter thread, as discussed above. Then, one can thread a thread insert with an internal thread the same as the original assembly into the larger bored out and threaded hole. Typical the external threads of such thread inserts are of a conventional helical design.

Referring to the drawings, FIGS. 6A, 6B and 6C illustrate an example of a thread insert of conventional helical design. An example of such a thread insert is the HELI-COIL® insert manufactured by Emhart LLC of Newark, Del. The thread insert is a coil of wire W, typically stainless steel, which has a diamond shaped cross section. The thread insert has a tang T at one end of the coil of wire W that can be engaged by a tool to facilitate installation of the thread insert. The tang T may be left in place after installation or, less typically, removed. However, even when the tang T is removed after installation there is generally some remnant of the tang T protruding from the coil of wire W.

When the thread insert is installed into a hole tapped for a thread insert, the thread insert typically provides conventional internal screw threads that accommodate standard bolts or screws. However, the thread insert does not allow for a proper seal for a port fitting, like a tube nut, as the port fitting will not seat on the seat at the bottom of the bore when the tang of the coil or remnant of the tang are between the port fitting and the seat at the bottom of the bore.

Additionally, a conventional thread insert has a tendency to become loose when the port fitting is removed for disassembly or, in some cases, the thread insert will unscrew from the body when removal of the port fitting is attempted thus complicating the disassembly/reassembly process. In addition, if the port fitting must provide a sealed engagement with the body, such as is the case when the application requires a pressure seal, a conventional thread insert sometimes does not provide a positive seal between the external threads of the conventional thread insert and the wall of the body or between the internal threads of the conventional thread insert and the external threads of the port fitting, which would be unacceptable in such an application.

In order to help prevent thread damage to a threaded bore, a threaded thread saver may be used. Referring to the drawings, FIGS. 7A, 7B, and 7C illustrate a typical threaded thread saver. The threaded thread saver has a first end with external threads ET. The threaded thread saver has a second end with external flats EF and internal threads IT (in an alternate embodiment, not shown, the threaded thread saver may have external threads ET at both ends with external flats EF formed on a portion intermediate the ends). The external flats EF are for engagement by a tool, such as a wrench. The internal threads IT on the second end are to engage a threaded connector, such as a port fitting or tube nut. The threaded thread saver has an internal seat S against which the threaded connector seals. The first end of the threaded thread saver also has an external sealing surface SS formed on the first end of the threaded thread saver.

Typically, the first end of the threaded thread saver is first threaded into a threaded bore of a body to which a component, such as a hydraulic tube for example, is to be connected, with the sealing surface SS sealing against a mating surface in the threaded bore of the body. A tube nut, or other threaded connector, is then connected to the second end of the threaded thread saver, as discussed in the preceding paragraph.

The threaded thread saver is less likely to be cross threaded than a tube nut, for example, since, when following this sequence of assembly, there is no possibility of the threaded thread saver being held slightly of axis by a tube when the threaded thread saver is first connected to the body. Use of the threaded thread saver can reduce costs overall as the additional cost of the threaded thread saver may be more than off set by the savings from the reduction in damage to relatively expensive hydraulic components, such as HCUs, due to cross-threading. If damage occurs during the connection of the port fitting or tube nut to the threaded thread saver, it is the threaded thread saver and the port fitting or tube nut that is damaged. The damaged threaded thread saver and the damaged port fitting or tube nut may then be replaced.

The threaded thread saver provides for a more positive seal than the conventional thread insert, as the threaded thread saver has the sealing surface SS on the small end thereof to positively engage the mating surface (seat) in the bore in the body, and also is provided with the internal seat S against which a tube nut can seal. Although the threaded thread saver may better provide for a seal for a port fitting, such as a tube nut, when compared to the conventional thread insert, the threaded thread saver requires two seals, i.e., a seal between the internal seat S of the threaded thread saver and the tube nut or port fitting and a seal between the sealing surface SS of the threaded thread saver and the mating surface of the body. Additionally, the threaded thread saver has the potential, like the conventional thread insert, to become loose or removed during disassembly or removal of a port fitting.

### SUMMARY OF THE INVENTION

A cylindrical body having a first end and having a second end, the outer diameter of the cylindrical body is greater at the first end of the cylindrical body than the outer diameter of the cylindrical body at the second end of said cylindrical body. The interior surface of the cylindrical body defines a bore. The bore has a plurality of threads formed thereon. The exterior surface of the cylindrical body defines a circumferential groove. The cylindrical body is capable of a sealed engagement with another body.

The invention includes a hardened insert permanently fixed in a bore formed in a component body. Further, and more specifically, the invention relates to the provision of the insert having hardened internal screw threads and the insert having an exterior adapted to be fixed in the bore. The exterior of insert defines a circumferential groove which when pressed into a component body will create a clinched gland. The insert is to be threadably engaged by other threaded devices, such as that of mechanical threaded fasteners or hydraulic port fittings used in components of automobiles, aircraft, and the like. In those applications where the insert is part of a fluidic circuit, a seal is formed between the insert and the component body.

### BRIEF DESCRIPTION OF THE DRAWINGS

FIG. 1 is a perspective view of a typical valve body employing thread savers in accordance with this invention.

FIG. 2 is a perspective view, partially broken away, of one of the thread savers illustrated in FIG. 1 being assembled with a tube with an ISO Flare and a tube nut.

FIG. 3 is a view similar to FIG. 2 except having a tube with an Inverted Flare provided.

FIG. 4 is a view similar to FIG. 2 except showing the thread saver installed in a blind hole in a part receiving a bolt to fasten the part to another part.

FIG. 5 is a flow chart of a method of installing one of the inventive thread savers to a body.

FIG. 6A is a perspective view of a prior art thread insert of conventional helical design.

FIG. 6B is a plan view of the thread insert of FIG. 6A.

FIG. 6C is a perspective view of a section of the thread insert of FIG. 6B, taken along the line 6C-6C.

FIG. 7A is a perspective view of a prior art threaded thread saver of conventional design.

FIG. 7B is a plan view of the threaded thread saver of FIG. 7A.

FIG. 7C is a perspective view of a section of the threaded thread saver of FIG. 7B, taken along the line 7C-7C.

### DETAILED DESCRIPTION OF THE PREFERRED EMBODIMENT

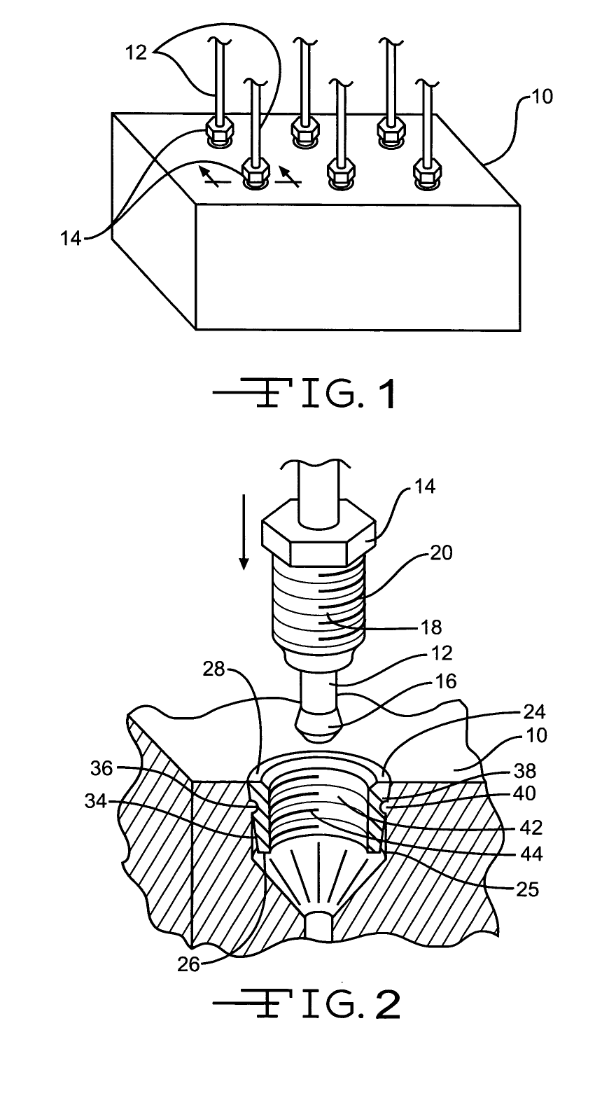

Referring again to the drawings, FIG. 1 illustrates a component body, indicated generally at 10. The illustrated body 10 is a typical valve body for a Hydraulic Control Unit (HCU) such as is employed in automotive brake systems. However, it will be appreciated, in light of the following disclosure, that the invention may be practiced on bodies other than automotive HCUs and that the body 10 may be the body of any component to which one would want to make a threaded connection with another part, such as the body of a brake caliper or a master cylinder. Indeed, as will be explained below, the body 10 need not be part of a fluidic circuit at all, but rather just be a component in a mechanical assembly.

The body 10 is composed of a first material. The first material, in a preferred embodiment, is a malleable metallic material such as aluminum, but it is contemplated that the first material may be any material suitable for the application to which the thread saver of the invention can be fixed as described below. A bore 25 is formed in the body 10 by plunge drilling or any suitable means.

A plurality of tubes 12 are provided. Each tube 12 provides a fluid passage connection between the body 10 and a remote hydraulic component (not shown), such as a vehicle brake. A plurality of threaded connectors in the form of tube nuts 14 are provided, each tube nut 14 connecting a tube 12 to the body 10.

Referring to FIG. 2, the tube 12 extends through the tube nut 14. The tube 12 terminates at an end 16. The end 16 of the tube 12 is flared in the embodiment illustrated in FIG. 2, the end 16 is shown with a standard flare known as an ISO Flare. The end 16 of the tube 12 is received by the bore 25, which has been formed in such a way as to receive the end 16 of the tube 12.

The tube nut 14 has an exterior surface 18. A first plurality of threads 20 is formed on the exterior surface 18 of the tube nut 14. The tube nut 14 is composed of a second material. Typically, for automotive brake systems, the second material of which the tube nut 14 is composed would be a metal such as steel or brass, but the tube nut 14 may be made of any suitable material.

A thread saver 24, to threadably receive the tube nut 14, is installed in the body 10 at the bore 25. The thread saver 24 is generally cylindrical and hollow in shape. The thread saver 24 has a first end 26 and a second end 28. The first end 26 has an outside diameter smaller than the diameter of the bore 25. The second end 28 has an outside diameter larger than the diameter of the bore 25. The thread saver 24 has an exterior surface 34. An annular groove 36 is formed in the exterior surface 34 of the thread saver 24. The groove 36 is disposed between the first end 26 and the second end 28, preferably closer to the second end 28. The thread saver 24 is preferably inward tapered from the groove 36 to the first end 26. The thread saver 24 has an interior surface 42. A second plurality of threads 44 is formed on the interior surface 42 of the thread saver 24.

The thread saver 24 is composed of a third material. The third material, in a preferred embodiment, is a hard metallic material such as steel, but it is contemplated that the third material may be any suitable material. The third material is harder than the first material, so that when the thread saver 24 is pressed in the body 10, at the bore 25, the relatively softer first material of the body 10 is disposed by the thread saver 24 formed of the harder third material. Some of the first material of the body 10 is displaced into the groove 36 as indicated generally at 40. The thread saver 24 is thus permanently fixed in the bore 25. As used in this description the phrase “permanently fixed” means: substantial deformation or breakage will occur to the thread saver 24 or to the body 10 in an attempt to remove the thread saver 24 from the body 10 after installation. The third material is harder than the second material, so that when the tube nut 14 is threadably connected to the thread saver 24 if a cross threading, or any other thread damaging occurrence, happens the first plurality of threads 20 is damaged and not the second plurality of threads 44.

The thread saver 24 does not interfere with the conventional seal between the tube 14 and the body 10.

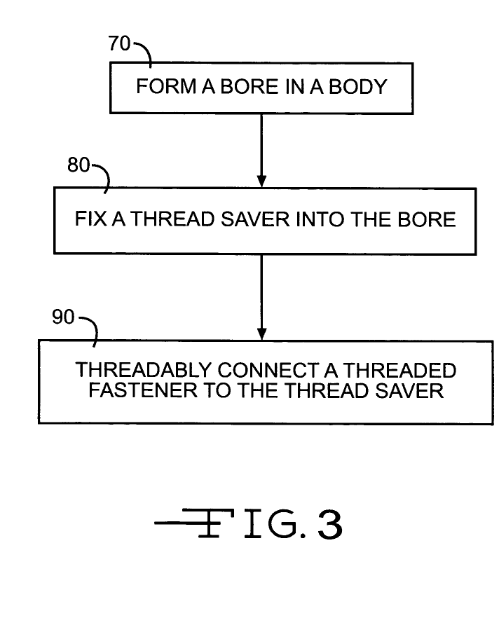

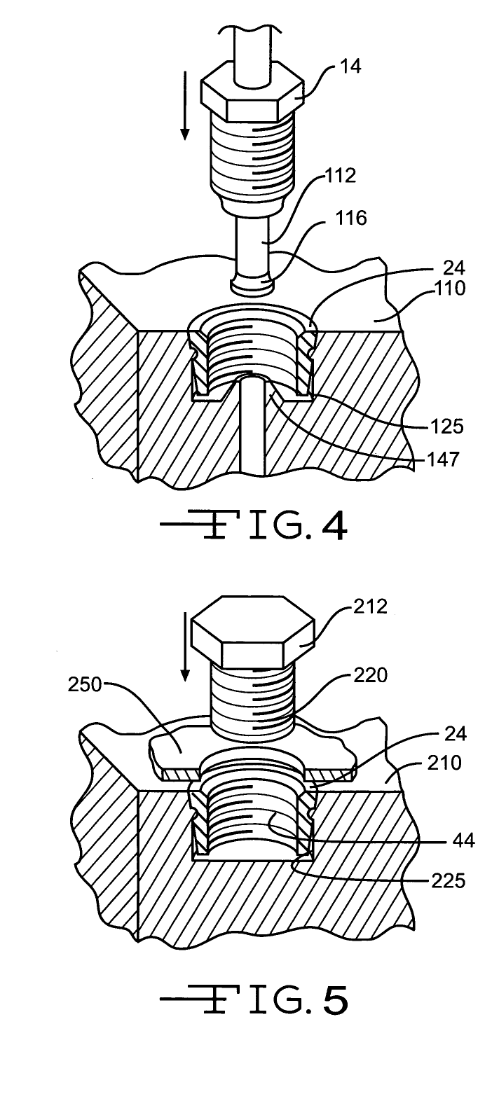

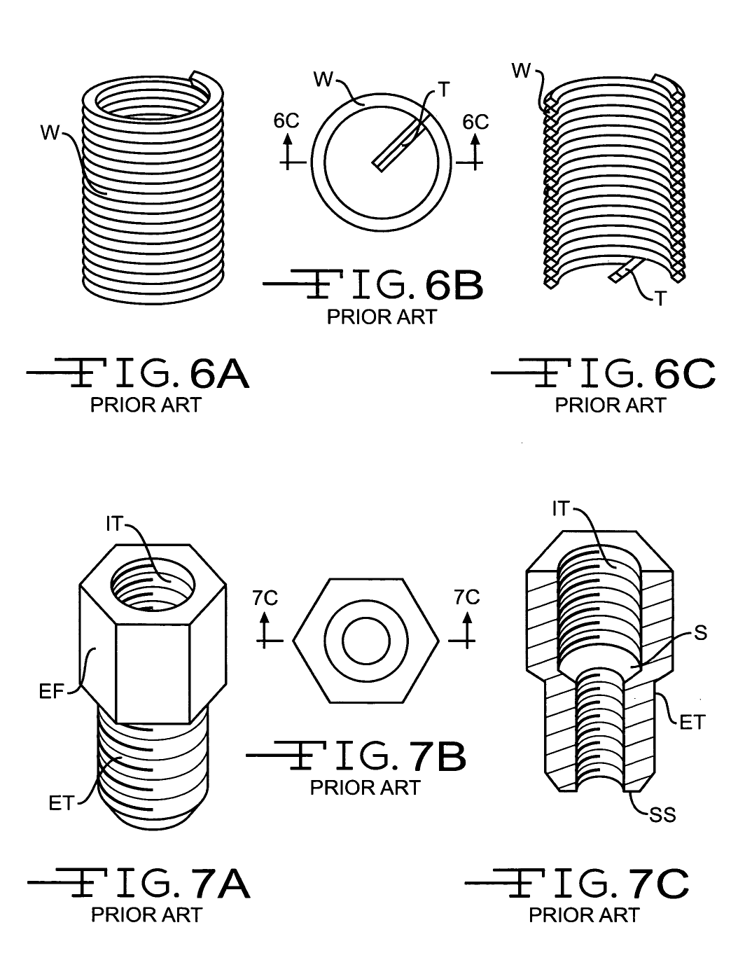

Referring to FIG. 3, there is illustrated a method of assembly of the inventive thread saver 24 in accordance with this disclosure. In a first step 70, the bore 25 is formed into the body 10, for example, by drilling.

In a second step 80, the thread saver 24 is fixed into the bore 25 in the body 10. In the embodiment of the thread saver 24 described above, as the thread saver 24 is pressed into the bore 25, the relatively softer first material of the body 10 is disposed by the thread saver 24 and some of the first material of the body 10 is displaced into the groove 36. However, one skilled in the art will appreciate that the thread saver 24 embodied in this invention need not be installed by press methods. The thread saver 24 can be attached to the body 10, or other bodies, by any means suitable for the various materials of composition, such as by adhesive(s), brazing, welding, roll forming, staking, etc. It is further contemplated that the exterior surface shape of the thread saver 24 may be modified to best accomplish these alternative methods of attachment.

FIG. 3 also illustrates a third step 90, in which a threaded fastener, such as a tube nut, is threadably connected to (screwed into) the thread saver. One skilled in the art will appreciate that connectors and fasteners other than tube nuts, such as bolts, can be threadably connected to the thread saver.

The first step 70 and the second step 80 complete the assembly of the thread saver 24 to the body 10, and may be performed independently of subsequent steps, and may be performed by different parties. Both the first step 70 and the second step 80 may be performed, for example, by a brake system manufacturer. However, it is also anticipated that the first step 70 may be performed by one party, such as a brake component manufacturer, and the second step 80 may be performed by another party, such as a brake component assembler.

Furthermore, although the third step 90 may be performed by the performer of the first step 70 or the performer of the second step 80, it is anticipated that the third step 90 may be performed by some party other than the performer of the first step 70 or the performer of the second step 80, for example an automotive manufacturer connecting brake lines to an HCU provided by the brake system manufacturer.

Referring to FIG. 4, the use of the thread saver 24 of the invention is shown in another application, in this case, used with a tube 112 having an inverted flare formed on an end 116. The thread saver 24 is installed in a body 110 at a bore 125. The bore 125 has been formed in such a way as to receive the end 116 of the tube 112. The bore 125 has a seat 147 formed at the bottom of the bore 125. When the associated tube nut 14 is threaded into the thread saver 24, the tube nut 14 drives the end 116 into sealing engagement with the seat 147. As described above, if the tube nut 14 were to be cross threaded in the thread saver 24, then the threads of the tube nut 14 would be damaged and not the threads of the relatively harder and less malleable thread saver 24.

Referring to FIG. 5, another application of the thread saver 24 of the invention is shown. The thread saver 24 is installed in a bore 225 of a body 210. A threaded connector in the form of a bolt 212 is provided. The bolt 212 is with a plurality of threads 220. The bolt 212 is composed of a second material. The second material is softer than the first material that the thread saver 24 is composed of, so that when the bolt 212 is threadably connected to the thread saver 24, if the bolt 212 is cross threaded, or any other thread damaging event occurs, the threads 220 of the bolt 212 are damaged and not the of threads 44 of the permanently attached thread saver 24. The bolt 212 connects another component 250 to the body 210 to form a mechanical assembly. However, it will be appreciated that the component 250 may be any suitable component, such as mounting hardware or another body or any part that is connectable by means of a bolt or other threaded fastener.

In summary, the invention may include various aspects, which differ from the prior art and provide advantages over the prior art. Of course, it will be recognized in light of the above disclosure the list of various aspects of the invention highlighted hereafter is neither a comprehensive list of the advantages of the invention, nor a list of required features of the invention (i.e., some embodiments of the invention may not have some of the features described below). The scope of the invention to be protected is defined by the claims. While the principal and mode of operation of this invention have been explained and illustrated in its preferred embodiment, it must be understood that this invention may be practiced otherwise than as specifically explained and illustrated without departing from its spirit or scope.

First, the inventive design utilizes a permanently fixed thread saver installed in a valve body. The permanent fixation, for example, may be achieved by use of a clinch gland to retain the thread saver in the valve body. This allows reduced packaging size in comparison to threaded thread saver designs, since there is no need for external flats or external space for threads for tube nuts. The inventive design also reduces the cost of machinery for assembly to that of a simple press instead of a torque station. The inventive design also requires less material to make a thread saver as compared to the threaded thread saver design. The inventive design also provides for a simplified machining process, for example by allowing through drilling and tapping of the thread saver. Assembly of conventional thread inserts and threaded thread inserts require plunge drills and bottoming taps with precise controls on tool depth, for example to form the internal seat in the threaded thread saver. As a result, the tooling requires slower feed rates (longer cycle time), is more expensive and tool lives are shorter.

Second, the inventive design prevents damage to the body (such as an HCU) from cross threading by using a material that is harder than the threaded fasteners (e.g. tube nuts) being screwed into the thread saver. If a cross thread does occur, the thread saver attached to the body is not damaged, and the easily replaced and inexpensive thread fastener (tube nut) is replaced.

Third, the inventive design accommodates different tube nut threads and diameters to allow for “fool-proofing by design” (poka-yoke). At the same time, the thread savers thus provided with different internal threads and diameters could be formed with the same outside envelopes. Thus allowing protection for the OEM by providing thread savers of various internal threads and diameters so that unique tube nuts can be used for each brake line. This would allow reduced machining time on the control valve by using one tool to form uniform hole shapes for each port.

Fourth, the inventive design provides for one hydraulic seal between the brake tube and the valve body, similar to conventional designs without the use of thread savers. Conventional thread inserts and threaded thread savers require two hydraulic seals: a first between the thread insert or the thread saver and the valve body and a second between the thread insert or the thread saver and the brake tube.

The clinching feature of the inventive design provides retention to the valve body but is not required to provide a hydraulic seal. In previous thread saver designs, the brake tube was required to seal on the hard steel surface of the thread insert or the thread saver, which is relatively unyielding, and sensitive to surface imperfections or misalignments of the brake tubes during assembly. Either of these conditions could cause vacuum or fluid leaks between the brake tube and the thread insert or the thread saver. The inventive design features a tube seat machined into the relatively soft aluminum valve body, thereby providing conditions that are more favorable for achieving the desired results.

1-11. (canceled)

12. A thread saver assembly comprising:
a main body having a bore formed therein and having a fluid passageway communicating with said bore formed therein;
a threaded connector;
a tube having a fluid passageway, said tube extending through said threaded connector; and
a thread saver apparatus, said apparatus having a circumferential groove formed in an exterior surface thereof for receiving material of said main body to fix said apparatus to said main body when said apparatus is installed in said main body, said apparatus receiving said threaded connector such that said threaded connector urges said tube into sealing engagement with said main body to provide fluid communication between said fluid passageway of said tube and said fluid passageway of said main body.

13. The thread saver assembly of claim 12 wherein said apparatus is frustoconical.

14. The thread saver assembly of claim 13 wherein said exterior surface of said apparatus is uniformly tapered, except for said circumferential groove, from a first end disposed in said bore of said main body to a second end facing away from said main body.

15. The thread saver assembly of claim 14 wherein said apparatus has a threaded bore of generally uniform diameter formed longitudinally therethrough so that a first wall thickness of said apparatus adjacent said first end thereof is less than a second wall thickness thereof adjacent said second end thereof.

16. The thread saver assembly of claim 15 wherein said threaded bore in said apparatus is chamfered at the opening thereof through said second end of said apparatus to facilitate assembly of said threaded connector thereto.

17. A thread saver assembly comprising:
a main body having a bore formed therein and having a fluid passageway communicating with said bore formed therein;
a threaded connector;
a tube having a fluid passageway, said tube extending through said threaded connector; and
a thread saver apparatus installed in said main body, said apparatus receiving said threaded connector such that said threaded connector urges an end of said tube into sealing engagement with said main body to provide fluid communication between said fluid passageway of said tube and said fluid passageway of said main body, said thread saver apparatus including:
a generally cylindrical body having a first end and having a second end, the outer diameter of said generally cylindrical body being greater at said first end of said generally cylindrical body than the outer diameter of said generally cylindrical body at said second end of said generally cylindrical body;
an interior surface of said generally cylindrical body, said interior surface defining a bore through said generally cylindrical body, said interior surface having a plurality of threads formed thereon; and
an exterior surface of said generally cylindrical body, said exterior surface defining a circumferential groove.

18. The thread saver assembly of claim 17, wherein:
said generally cylindrical body has a first hardness; and
said main body has a second hardness, and said first hardness being greater than said second hardness.

19. The thread saver assembly of claim 18, wherein said threaded connector has a third hardness, said third hardness being less than said first hardness.

20. The thread saver assembly of claim 17, wherein said generally cylindrical body is permanently fixed in said bore defined in said main body.

21. The thread saver assembly of claim 17, wherein said generally cylindrical body is composed of a hard metallic material.

22. The thread saver assembly of claim 21, wherein said generally cylindrical body is composed of steel.

23. The thread saver assembly of claim 17, wherein said main body is composed of a malleable metallic material.

24. The thread saver assembly of claim 23, wherein said main body is composed of aluminum.

25. The thread saver assembly of claim 17, wherein said tube has an ISO flare formed on the end thereof in sealing engagement with said main body.

26. The thread saver assembly of claim 17, wherein said tube has an inverted flare formed on the end thereof in sealing engagement with said main body.
